(19) United States
(12) Patent Application Publication
(10) Pub. No.: US 2002/0101577 A1
(43) Pub. Date: Aug. 1, 2002

(54) Optical fiber test method and apparatus

(76) Inventors: Theodore N. Thwing, Edmonds, WA (US); Jeffrey S. Bottman, Seattle, WA (US)

Correspondence Address: George T. Noe, Fluke Corporation, Legal Dept. MS 203A, P.O. Box 9090, Everett, WA, 98206, US

(21) Appl. No.: 09/774,471

(22) Filed: Jan. 30, 2001

(51) Int. Cl. G01N 21/00

(52) U.S. Cl. 356/73.1

(57) ABSTRACT

A method and apparatus to determine loss and length characteristics of a single optical fiber. An optical fiber to be tested is connected at its near end to the test port of an instrument having a light source, a detector, and a directional coupler. The far end of the optical fiber is terminated in a mirror. Light from the light source propagates down the optical fiber to the mirror, where it is reflected back to the detector. The results are processed by measurement circuitry and displayed.

### BACKGROUND OF THE INVENTION

This invention relates generally to testing fiber-optic systems, and in particular to a method and apparatus for testing certain characteristics of an optical fiber.

Local area networks (LANs) that connect a vast number of personal computers, workstations, printers, file servers and related devices in buildings and offices are known to manufacturers of test equipment designed to test LANs as the premises market. In the premises market, LAN cables may be routed through walls, floors, and ceilings of a building, or even between buildings.

Fiber optic cable systems, while more costly than copper wire cable systems, are becoming more prevalent in LANs to meet the increasing demands for network speed and associated bandwidth to handle gigabit/second data transmission rates. The fiber optic cables used in these systems typically comprise optical fibers with special connectors or adapters to ensure that optical fiber ends align and match appropriately.

The tasks of installing or re-routing fiber optic cables typically fall on a contracted cable installer or in-house network specialist. Before such fiber optic cables are installed, it is prudent to perform tests to ensure that characteristics of the optical fibers meet the minimum standards established by industry groups such as the Electronics Industry Association (EIA) and the Telecommunications Industry Association (TIA) for use in the fiber-optic premises network. Such characteristics include, among others, optical power loss through the fiber, fiber length, and bandwidth capability.

One conventional testing method is optical time domain reflectometry. Optical time domain reflectometers (OTDRs) compute and display loss over distance, and, from reflections from connectors, splices, faults and the fiber material itself, provide an indication of events along the fiber. However, OTDRs are expensive and optimized more for measuring long optical fiber systems found in the telecom industry.

### SUMMARY OF THE INVENTION

In accordance with the present invention, a method and apparatus is provided to determine the characteristics of a single optical fiber. An optical fiber to be tested is connected at its near end to the test port of an instrument having a light source, a detector, and a directional coupler. The far end of the optical fiber is terminated in a mirror. Light travels from the light source through the directional coupler and into the optical fiber. The light propagates down the optical fiber to the mirror, where it is reflected back into the optical fiber. The reflected light travels back through the optical fiber to the test instrument, where it travels through the directional coupler to the detector. The test instrument has measurement circuitry and a display device for measuring and displaying the length and optical loss associated with the optical fiber. By sending light pulses into the optical fiber and measuring the time it takes for a reflected pulse to return to the detector, the length of the optical fiber can be determined.

These test methods have been performed satisfactorily on optical fibers up to one kilometer in length using an instrument designed for testing optical fiber networks in the so-called premises market, which has come to mean buildings and campus settings, as distinguished from the telecom market.

Additional testing capability may be provided by use of a mirror that permits a small amount of light to pass through to a detector placed on the far side of the mirror. This facilitates communication via light pulses over the optical fiber being tested that allows test result indicators at the far end to indicate test status or results.

Other objects, features, and advantages of the present invention will become obvious to those having ordinary skill in the art upon a reading of the following description when taken in conjunction with the accompanying drawings.

### BRIEF DESCRIPTION OF THE DRAWINGS

FIG. 1 is a schematic diagram of a test setup in accordance with the present invention for testing a single optical fiber;

FIG. 2 is a schematic diagram of a reference test setup to obtain reference values for the test instrument;

FIG. 3 shows a mirror placed at the far end of an optical fiber;

FIG. 4 shows a mirror created by sputtering metal onto the end of a ceramic connector ferrule;

FIG. 5 is a cross section of the connector of FIG. 4 showing the mirror surface in contact with the optical fiber; and

FIG. 6 is a partial schematic diagram showing a detector on the far side of the mirror for additional test capability.

### DETAILED DESCRIPTION OF THE INVENTION

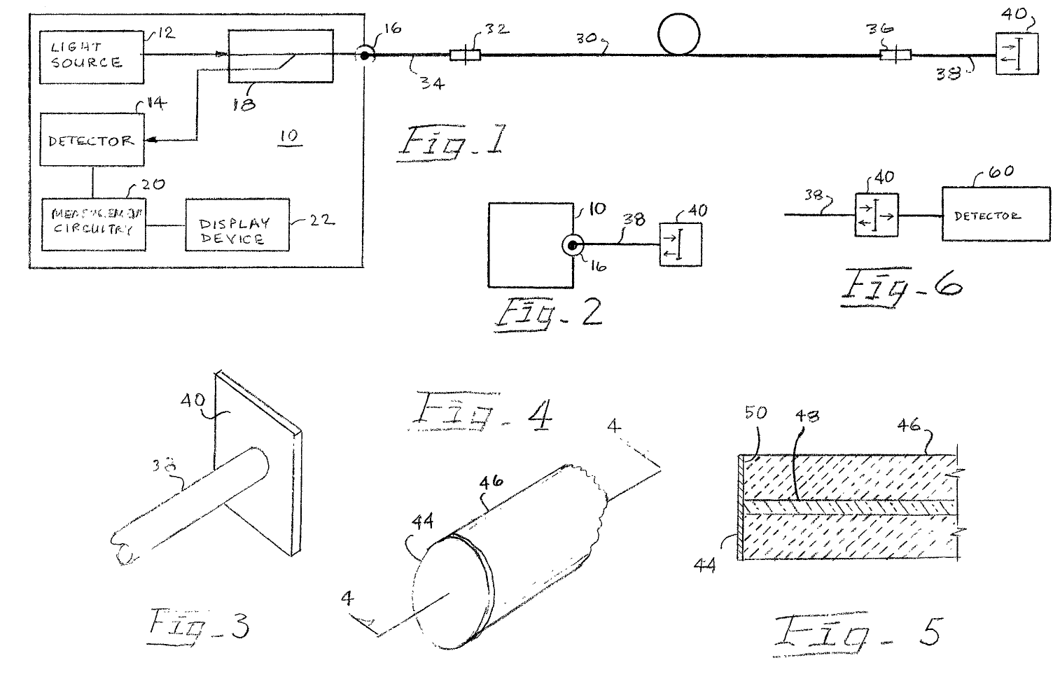

Referring to FIG. 1 of the drawings, there is shown a schematic diagram of a test setup for testing a single optical fiber. A test instrument 10 includes a suitable light source 12 and a detector 14 connected to a common test port 16 via a directional coupler 18 for testing optical fibers. Light sources, detectors, and directional couplers are well known components to those skilled in the art. The directional coupler used in testing the present invention is a coupler with an insertion loss at 850 nanometers of 3.3 decibels (dB) between the primary port and the common output port, and 3.4 dB between the secondary port and the common output port. Instrument 10 may suitably include measurement circuitry 20, which may include an analog-to-digital converter, digital processing circuits and memory, and a display device 22, such as a liquid-crystal display (LCD), to display measurement results.

The near end of an optical fiber or fiber link 30 to be tested is connected through an adapter 32 to a short near-end optical fiber patch cord 34, which in turn is connected to the test port 16 of instrument 10. The far end of optical fiber 30 is likewise connected through an adapter 36 to a short optical fiber patch cord 38, the far end of which is terminated by a reflective mirror 40. The optical fiber link 30 and optical fiber patch cords 34 and 38 are typically optical fibers with connectors at each end. In the connectors, the optical fibers are embedded in ferrules with flat end faces to provide face-to-face contact between joining connectors, and hence, joining optical fibers. The connector ferrules are typically of ceramic material to provide a robust protective environment for the delicate optical fiber ends, but other materials such as plastic or stainless steel are also used. The adapters 32 and 36 include internal alignment sleeves to bring the fiber ends together in face-to-face contact, and therefore eliminate axial misalignment or any air gap that would result in an abrupt change in refraction in the system. The insertion loss of the adapters is required by industry standards to be less than 0.75 dB per connection, but typically is much less than that.

Light from light source 12 travels through the directional coupler 18, the near-end patch cord 34, the optical fiber link 30, and the far-end patch cord 38 to the mirror 40, where it is reflected back through the same path to the directional coupler 18 and then to the detector 14, where a measurement of optical power is made by measurement circuitry 20. From this measurement and knowledge of the transmitted optical power, optical loss is calculated, taking into account the fact that the light traveled down the optical fiber and back. A point to keep in mind is that measurements made using this method must be divided by a factor of two since the light travels down the optical fiber and back. That is, the raw information received by detector 14 represents twice the amount of light reduction or loss that it would be if the detector 14 were to be placed at the far end of the optical fiber in place of the mirror. The calculated optical loss of the optical fiber 30 is displayed on display device 22.

By sending light pulses into the optical fiber 30 and measuring the time it takes for a reflected pulse to return to detector 14, the length of optical fiber 30 can be determined. Again, keep in mind that the measured time must be divided by a factor of two in calculating length. Again, lengths of paths not associated with optical fiber 30, for example, the patch cords, must be subtracted from the measurement.

Referring to FIG. 2, a reference test setup for determining optical power received after any losses associated with instrument 10 and with mirror 40 is shown. This reference test setup also measures the propagation delay time from the light source 12 to the detector 14. The propagation delay time so measured easily can be converted to length or distance. For convenience, the details of instrument 10 are not shown, but we can assume the details are the same as shown in FIG. 1. Here, with reference to FIG. 2, light from light source 12 is transmitted directly into mirror 40 and the reflected light is detected by detector 14. Measurement circuitry 20 calculates the propagation delay time to be stored as a reference value for use in making optical fiber length measurements. For example, in subsequent measurements of the length associated with optical fiber 30 in FIG. 1, the difference between the stored reference value and the reflected propagation delay is proportional to twice the length of the optical fiber.

Further, with reference to FIG. 2, the reflected optical power value detected by detector 14 is stored by measurement circuitry 20 to be used as a reference value in making optical fiber loss measurements. For example, in subsequent measurements of the loss associated with optical fiber 30 in FIG. 1, the difference between the stored optical power value and the reflected optical power is the twice loss of the optical fiber and adapters 32 and 36. The losses associated with the patch cords 34 and 38 are negligible, and the insertion losses of adapters 32 and 36 must be no greater than a combined 1.5 dB to be within the acceptable limits provided by industry standards.

The mirror 40 may suitably be any planar reflective surface placed in contact with the end of an optical fiber such that the plane of the reflective surface is transverse to the axis of the optical fiber so that as much light as possible is reflected back in to the optical fiber as shown in FIG. 3 where a mirror 40 is placed at the end of far-end patch cord 38. Of course, no mirror will provide 100% reflection, so some loss will occur. But as pointed out above, this loss is taken into account when the reference values for instrument 10 are established.

While a mirror could be bonded or attached to an optical fiber as shown in FIG. 3, in the present invention metal was deposited by a sputtering process onto the highly-polished flat end of the ceramic ferrule of a connector to provide a reflective surface. See FIGS. 4 and 5. FIG. 4 shows a partial connector with metal 44 deposited on the end of a ceramic ferrule 46 to provide a mirror surface, and FIG. 5 is a cross-section thereof showing an optical fiber 48 in contact with the mirror surface 50. The type of metal used is not critical, so long as it exhibits reflective qualities. In the embodiment shown, nickel having a thickness of approximately 15,000 Angstroms was deposited on the flat, polished end of a ceramic ferrule. Note that the end of optical fiber 48 directly contacts the metallic reflective surface 50 so that there is no change in the index of refraction due to an air gap. The amount of metal deposited and the thickness thereof depends on the metal used and the application, and is not a critical factor. In fact, in some situations, it may be beneficial to reduce the thickness in order to allow a small percentage of light to pass through the mirror, as will be discussed below.

FIG. 6 shows a partial schematic diagram of a test setup in which a detector 60 is placed on the far side of mirror 40. By having a mirror that allows a small amount of light to pass therethrough to detector 60, additional testing capability may be provided to take advantage of a less-than-perfect mirror. For example, this facilitates communication via light pulses over the optical fiber being tested that allows test result indicators at the far end to indicate test status or results.

These test methods have been performed satisfactorily on optical fibers up to one kilometer in length using an instrument designed for testing optical fiber networks in the so-called premises market, which has come to mean buildings and campus settings, as distinguished from the telecom market. Moreover, the techniques described herein are applicable to both single-mode and multi-mode optical fibers. However, keep in mind that for testing single-mode optical fibers, wherein the light source is typically a laser, some isolation would be required to prevent light from re-entering the light source and disrupting its proper operation.

While we have shown and described the preferred embodiment of our invention, it will be apparent to those skilled in the art that many changes and modifications may be made without departing from our invention in its broader aspects. It is therefore contemplated that the appended claims will cover all such changes and modifications as fall within the true scope of the invention.

What we claim as our invention is:

1. An apparatus for testing an optical fiber, comprising:
a test instrument having a test port coupled to a near end of said optical fiber, said test instrument having a light source and a detector coupled via a directional coupler to said test port; and
a mirror coupled to a far end of said optical fiber, said mirror being disposed transverse to the axis of said optical fiber to reflect light from said light source to said detector.

2. An apparatus in accordance with claim 1 wherein said instrument further includes measurement circuitry and a display device coupled to said detector.

3. An apparatus in accordance with claim 2 wherein said instrument stores reference values representative of optical loss associated with said mirror, said measurement circuitry using said reference values and said light reflected to said detector to calculate optical loss of said optical fiber.

4. An apparatus in accordance with claim 3 wherein said instrument further stores reference values representative of light path distance in a path from said light source to said detector without said optical fiber present in said path.

5. An apparatus in accordance with claim 2 wherein said light source produces light pulses, and said measurement circuitry measures a time period for one of said light pulses to propagate through said optical fiber to said mirror and back through said optical fiber to said detector after being reflected by said mirror.

6. A method of testing an optical fiber, comprising the steps of:
(a) coupling a light source and a detector to a near end of said optical fiber;
(b) providing a mirror at a far end of said optical fiber to reflect light transmitted from said light source back to said detector; and
(c) measuring optical power received by said detector.

7. A method of testing an optical fiber in accordance with claim 6, further comprising the steps of:
(d) storing as reference values the values of optical power returned from said mirror without said optical fiber in place; and
(e) calculating optical loss of said optical fiber by performing calculations using said reference values and said optical power measured by said detector.

8. A method of testing an optical fiber in accordance with claim 6, further comprising the steps of:
(d) providing light pulses from said light source into said near end of said optical fiber; and
(e) calculating propagation time for said light pulses to propagate through said optical fiber to said mirror and back through said optical fiber to said detector after being reflected by said mirror.
